(19) United States
(12) Patent Application Publication
(10) Pub. No.: US 2022/0122272 A1
(43) Pub. Date: Apr. 21, 2022

(54) DISPLAY PROCESSING DEVICE, DISPLAY PROCESSING METHOD, AND NON-TRANSITORY COMPUTER-READABLE STORAGE MEDIUM

(71) Applicant: Mitsubishi Electric Corporation, Tokyo (JP)

(72) Inventors: Yusuke NAKATA, Tokyo (JP); Yoshiyuki KATO, Tokyo (JP); Keiko IMAMURA, Tokyo (JP)

(73) Assignee: Mitsubishi Electric Corporation, Tokyo (JP)

(21) Appl. No.: 17/561,341

(22) Filed: Dec. 23, 2021

Related U.S. Application Data
(63) Continuation of application No. PCT/JP2019/028383, filed on Jul. 19, 2019.

(51) Int. Cl. G06T 7/246; G06T 11/20

(52) U.S. Cl. CPC G06T 7/246; G06T 2207/30241; G06T 2207/30232; G06T 11/203

(57) ABSTRACT

A display processing device includes: a processor to execute a program; and a memory to store the program which, when executed by the processor, performs processes of: (a) extracting a plurality of movement lines representing trajectories of moving bodies that leave a first area and arrive in a second area and/or trajectories of moving bodies that leave the second area and arrive in the first area; (b) obtaining, for each of the movement lines extracted by process (a), N-1 division points by dividing the movement line by a division number N, N being an integer not less than 2; (c) calculating N-1 average points by averaging coordinates of the division points obtained by process (b) and belonging to the different movement lines; and (d) drawing a movement line that passes through the N-1 average points obtained by process (c), the first area, and the second area.

### CROSS REFERENCE TO RELATED APPLICATION

This application is a continuation of International Application No. PCT/JP2019/028383, filed on Jul. 19, 2019, the disclosure of which is incorporated herein by reference in its entirety.

### BACKGROUND OF THE INVENTION

### 1. Field of the Invention

The present invention relates to a display processing device, a display processing method, and a non-transitory computer-readable storage medium.

### 2. Description of the Related Art

Conventionally, there is known a technique that calculates coordinates indicating movement trajectories of passersby or the like in a predetermined space of transportation facilities, commercial facilities, or the like, and displays movement lines of moving bodies on the basis of the calculated coordinates.

For example, Patent Literature 1 discloses a technique that extracts a person from image data and displays, together with a movement line, a direction in which the person faces toward an object and a time for which the person faces toward the object.

Also, for example, Patent Literature 2 discloses a technique that tracks the positions of passersby passing through a predetermined space to obtain passage trajectories (movement lines) and displays the movement lines of all the passersby who have passed through the predetermined space within a predetermined time.

Patent Literature 1: International Publication No. WO 2017/170084 (FIG. 5)

### Patent Literature 2: Japanese Patent Application Publication No. 2005-346617 (FIG. 6)

The technique disclosed in Patent Literature 1 has a problem in that it intends nothing but to display a single movement line.

Also, the technique disclosed in Patent Literature 2 has a problem in that although multiple movement lines are displayed, since the multiple movement lines are displayed while being overlapped, as the number of the displayed movement lines increases, it becomes more difficult to perceive the manner of movement of the moving bodies.

### SUMMARY OF THE INVENTION

The present invention has been made to solve the above problems, and is intended to draw a movement line obtained by averaging multiple movement lines representing trajectories of moving bodies that leave a first area and arrive in a second area and/or trajectories of moving bodies that leave the second area and arrive in the first area, thereby making it easy to perceive the manner of movement of the moving bodies.

A display processing device according to the present invention includes: a processor to execute a program; and a memory to store the program which, when executed by the processor, performs processes of: (a) extracting a plurality of movement lines representing trajectories of moving bodies that leave a first area and arrive in a second area and/or trajectories of moving bodies that leave the second area and arrive in the first area; (b) obtaining, for each of the movement lines extracted by process (a), N-1 division points by dividing the movement line by a division number N, N being an integer not less than 2; (c) calculating N-1 average points by averaging coordinates of the division points obtained by process (b) and belonging to the different movement lines; and (d) drawing a movement line that passes through the N-1 average points obtained by process (c), the first area, and the second area.

The display processing device of the present invention provides the advantage that it is possible to draw a movement line obtained by averaging multiple movement lines representing trajectories of moving bodies that leave a first area and arrive in a second area and/or trajectories of moving bodies that leave the second area and arrive in the first area, thereby making it easy to perceive the manner of movement of the moving bodies.

### BRIEF DESCRIPTION OF DRAWINGS

FIG. 1 is a configuration diagram of a display processing device according to an embodiment of the present invention.

FIG. 2 is a diagram illustrating a placement example of cameras in a factory.

FIG. 3 is a diagram illustrating an example of a movement line data management table 107.

FIG. 4 is a diagram illustrating an example of movement lines extracted by a movement line extraction unit 109.

FIG. 5 is a diagram illustrating two division points obtained by dividing each of movement lines D1, D2, and D3 into three.

FIG. 6 is a diagram illustrating a representative movement line R based on movement lines D1, D2, and D3.

FIG. 7 is a flowchart illustrating a process by the display processing device 100.

FIG. 8 is a diagram illustrating an example of a hardware device forming the system of FIG. 1.

FIG. 9 is a diagram illustrating a representative movement line by using arrows.

FIG. 10 is a diagram illustrating representative movement lines by using arrows.

FIG. 11 is a configuration diagram of a display processing device according to a third embodiment.

FIG. 12 is a diagram illustrating an example of a display screen.

FIG. 13 is a diagram illustrating slider bars displayed on a display 11.

### DETAILED DESCRIPTION OF THE INVENTION

### 1. First Embodiment

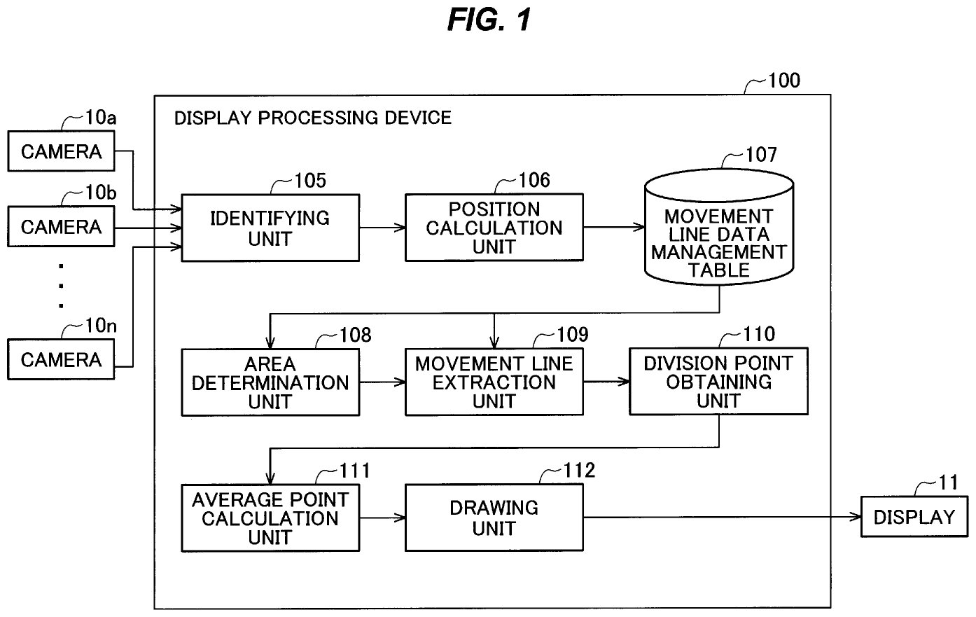

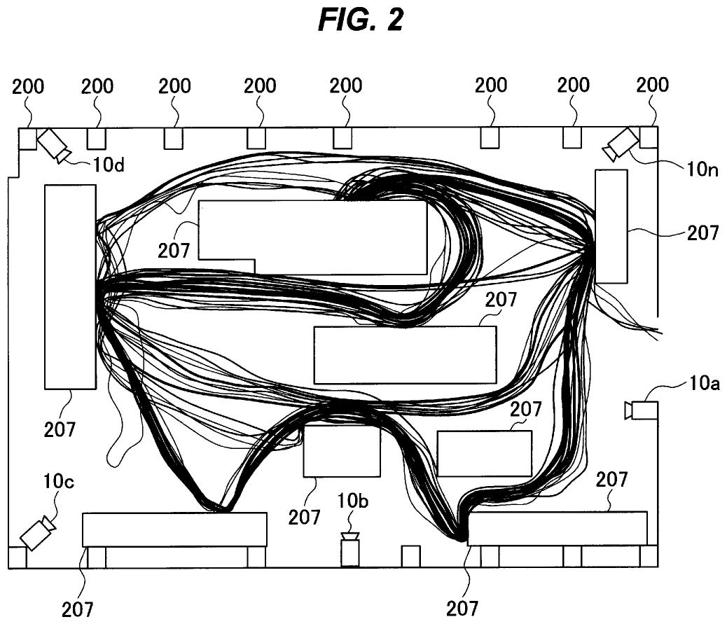

FIG. 1 is a configuration diagram of a display processing device according to an embodiment of the present invention. Cameras 10a to 10n are placed at locations with good views, such as locations near a ceiling in a facility, and image moving persons or objects (referred to below as moving bodies when they need not be distinguished from each other). The cameras 10a to 10n are placed at positions such that they can cooperate to seamlessly image moving bodies wherever the moving bodies are in a facility. FIG. 2 is a diagram illustrating a placement example of the cameras in a factory. In addition to the cameras 10a to 10n, building frames 200, such as columns and walls of the factory, and equipment 207, such as manufacturing equipment, robots, and working tables, are placed in the factory. To reduce the blind areas of objects to be imaged, the cameras 10a to 10n use lenses having wide angles of view to image wide areas.

An identifying unit 105 identifies the same one or more moving bodies moving in the facility from images imaged by the cameras 10a to 10n and tracks the identified moving bodies over the entire imaging area of the cameras 10a to 10n. As a method to identify moving bodies, it is possible to use an image identification method of recognizing unique markers or bar codes attached to work wears or helmets. It is also possible to use a moving body estimation method using machine learning. In the machine learning, learning may be performed so that even when multiple moving bodies pass each other or when part of moving bodies is hidden behind objects, the moving bodies can be properly identified.

A position calculation unit 106 calculates coordinates indicating movement trajectories of the tracked moving bodies. In general, coordinates of moving bodies calculated from images imaged by cameras are represented by local coordinate systems (camera coordinate systems) unique to the individual cameras, and thus the position calculation unit 106 performs coordinate transformation from the camera coordinate systems to a global world coordinate system by using parameters, such as installation positions, orientations, angles of view of lenses, focal lengths of lenses, or aberrations of lenses of the cameras 10a to 10n. It is assumed that, to determine equations used in the coordinate transformation, position adjustment (calibration) between the cameras has been previously made by using the above-described parameters.

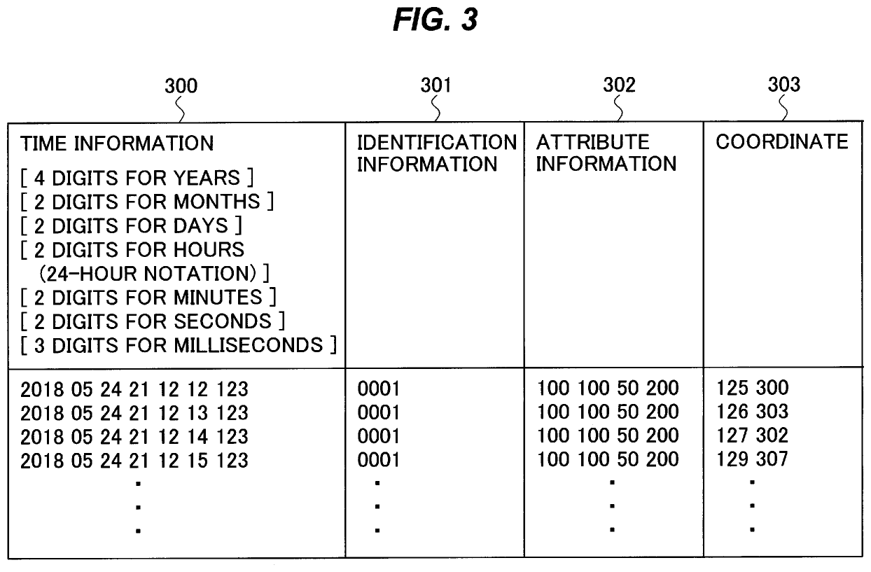

In a movement line data management table 107, movement line data indicating the movement trajectories of the moving bodies output from the position calculation unit 106 is recorded. FIG. 3 is a diagram illustrating an example of the movement line data management table 107. In the movement line data management table 107, coordinates 303 indicating the movement trajectories of the moving bodies, time information 300 indicating the times when the moving bodies were located at the respective coordinates and that are at predetermined time intervals, identification information 301 for the moving bodies, and attribute information 302 of the moving bodies are recorded as the movement line data. The time information 300 is represented by, for example, four digits for years, two digits for months, two digits for days, two digits for hours (24-hour notation), two digits for minutes, two digits for seconds, and three digits for milliseconds. The identification information 301 is information, such as worker IDs, for uniquely identifying the moving bodies. The attribute information 302 is information associated with the identification information 301, and is information indicating areas where specific moving bodies are located. When the moving bodies are workers, the attribute information 302 indicates, for example, work areas to which the workers are assigned. Also, when the moving bodies are objects, the attribute information 302 indicates, for example, areas or warehouses where the objects are temporarily stored. These information items can be recorded on a frame-by-frame basis of the camera imaging, but it may be determined depending on the processing loads of the identifying unit 105 and position calculation unit 106, a time interval of a movement line to be visualized, or the like.

An area determination unit 108 determines, from the movement line data recorded in the movement line data management table 107, areas where staying times of moving bodies are long.

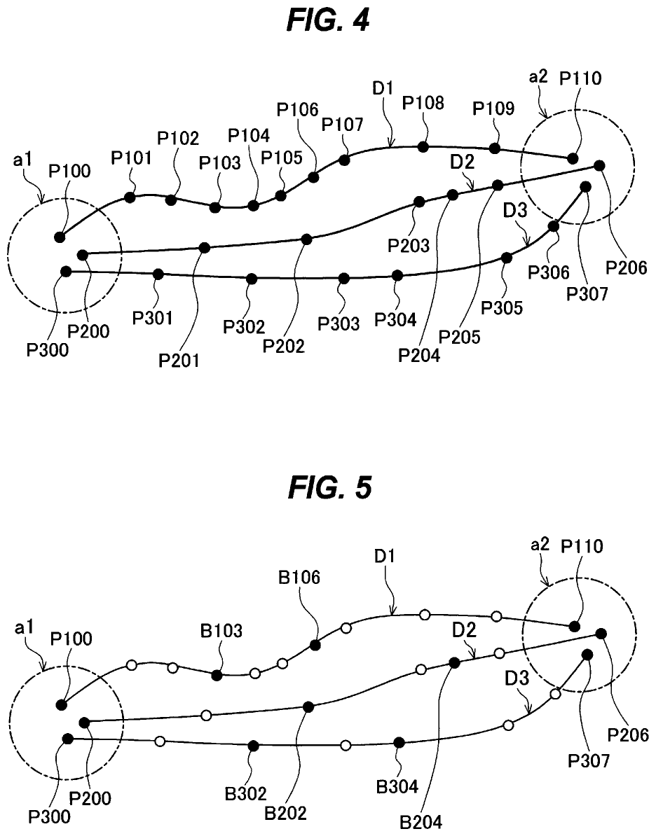

A movement line extraction unit 109 extracts multiple movement lines representing movement trajectories of moving bodies that move between the areas determined by the area determination unit 108. FIG. 4 is a diagram illustrating an example of the movement lines extracted by the movement line extraction unit 109. Areas a1 and a2 are areas determined by the area determination unit 108; area a1 will be referred to as a departure area, and area a2 will be referred to as an arrival area. Lines D1, D2, and D3 are movement lines representing movement trajectories of moving bodies that move from departure area a1 to arrival area a2, and are indicated by coordinates P100 to P110, P200 to P206, and P300 to P307, respectively. The movement line extraction unit 109 extracts movement lines D1, D2, and D3 by acquiring coordinates of movement lines recorded in the movement line data management table 107 (FIG. 3).

A division point obtaining unit 110 obtains, for each of the movement lines extracted by the movement line extraction unit 109, coordinates of N-1 division points by dividing the movement line by a division number N, N being an integer not less than 2. FIG. 5 is a diagram illustrating two division points obtained by dividing each of movement lines D1, D2, and D3 into three. Of the coordinates constituting movement lines D1, D2, and D3, the division point obtaining unit 110 obtains two coordinates as division points from each of coordinates P101 to P109, P201 to P205, and P301 to P306 located between coordinates (departure points) P100, P200, and P300 belonging to departure area a1 and coordinates (arrival points) P110, P206, and P307 belonging to arrival area a2. The division points are obtained such that the sampling intervals are regular, and for movement line D1, coordinates P103 and P106 are obtained as division points B103 and B106. Similarly, for movement line D2, coordinates P202 and P204 are obtained as division points B202 and B204, and for movement line D3, coordinates P302 and P304 are obtained as division points B302 and B304.

An average point calculation unit 111 calculates coordinates of N-1 average points by averaging the coordinates of the division points obtained by the division point obtaining unit 110 and belonging to the different movement lines. Also, the average point calculation unit 111 calculates, as an average departure point, an average of the coordinates of the departure points included in departure area a1, and calculates, as an average arrival point, an average of the coordinates of the arrival points included in arrival area a2.

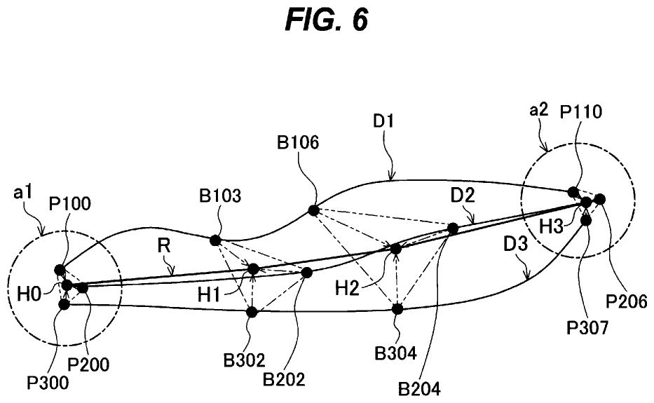

A drawing unit 112 draws a line that passes through the average departure point, N-1 average points, and average arrival point calculated by the average point calculation unit 111. Thereby, it is possible to obtain a representative movement line based on the multiple movement lines extracted by the movement line extraction unit 109. FIG. 6 is a diagram illustrating the representative movement line R based on movement lines D1, D2, and D3. In FIG. 6, point H0 is the average departure point, point H3 is the average arrival point, point H1 is the average point of division points B103, B202, and B302, and point H2 is the average point of division points B106, B204, and B304. The movement line R representing movement lines D1, D2, and D3 is drawn by connecting the average departure point HO, average points H1 and H2, and average arrival point H3.

A display 11 is, for example, a liquid crystal display, and displays various data output from the display processing device 100.

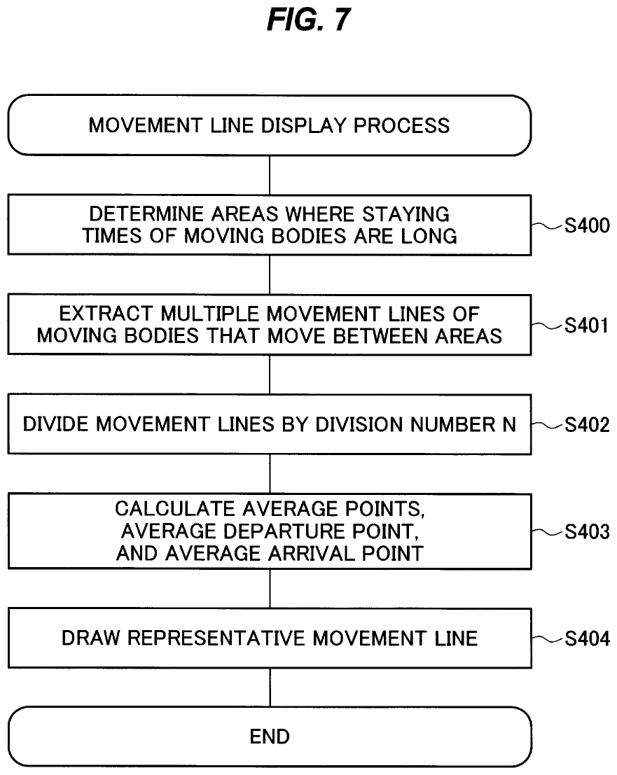

FIG. 7 is a flowchart illustrating a process by the display processing device 100. First, the area determination unit 108 determines, from the movement line data recorded in the movement line data management table 107, areas where staying times of moving bodies are long (S400). Then, the movement line extraction unit 109 extracts multiple movement lines representing movement trajectories of moving bodies that move between the areas determined by the area determination unit 108 (S401). Then, the division point obtaining unit 110 obtains, for each of the movement lines extracted by the movement line extraction unit 109, coordinates of N-1 division points by dividing the movement line by the division number N (S402), N being an integer not less than 2. Then, the average point calculation unit 111 calculates coordinates of N-1 average points by averaging the coordinates of the division points obtained by the division point obtaining unit 110 and belonging to the different movement lines. Also, the average point calculation unit 111 calculates, as an average departure point, an average of the coordinates included in departure area a1, and calculates, as an average arrival point, an average of the coordinates included in arrival area a2 (S403). The drawing unit 112 draws a movement line that passes through the N-1 average points, the average departure point included in departure area a1, and the average arrival point included in arrival area a2 that have been calculated by the average point calculation unit 111 (S404).

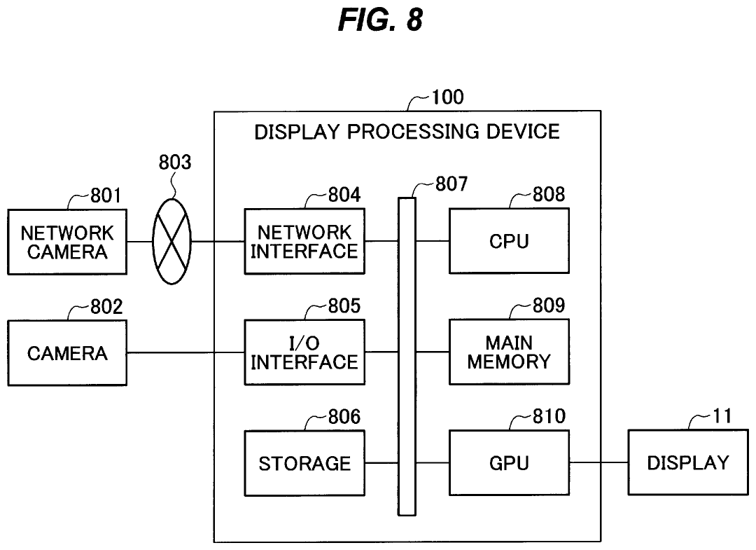

FIG. 8 is a diagram illustrating an example of a hardware device forming the system of FIG. 1. A CPU 808 implements the respective functions of the identifying unit 105, position calculation unit 106, area determination unit 108, movement line extraction unit 109, division point obtaining unit 110, average point calculation unit 111, and drawing unit 112 illustrated in FIG. 1 by executing a program or the like stored in a main memory 809. The main memory 809 is, for example, a non-volatile memory, and stores various programs executed by the CPU 808. A graphical processing unit (GPU) 810 is a graphics processor for drawing, and performs a process of drawing a movement line, a graphical user interface (GUI), or the like. The drawing by the GPU 810 is performed on a dedicated image memory (frame buffer). The GPU 810 outputs the drawn image to the display 11. The display 11 is, for example, a liquid crystal display, and displays the image output from the display processing device 100. The display 11 may be provided in the display processing device 100. A network interface 804 is an interface for inputting image data imaged by a network camera 801 via a network 803. The network 803 may be wired or wireless. An I/O interface 805 is an interface for inputting image data imaged by a camera 802 via an interface, such as a universal serial bus (USB) interface. The network camera 801 and camera 802 are an example of the cameras 10a to 10n of FIG. 1. A storage 806 stores various data (such as image data, the movement line data, or program data) that is processed by the CPU 808 or GPU 810. The storage 806 transfers the stored data to the CPU 808 or GPU 810 via a system bus 807.

In this embodiment, the display processing device 100 draws a movement line obtained by averaging multiple movement lines, and thereby can make it easy to perceive the manner of movement of moving bodies. Also, the display processing device 100 draws a movement line obtained by averaging multiple movement lines that leave an area where staying times of moving bodies are long or arrive in an area where staying times of moving bodies are long and thereby can make it easy to perceive the manner of movement of workers or parts around an area where the workers work or an area where the parts are stored, for example.

### 2. Second Embodiment

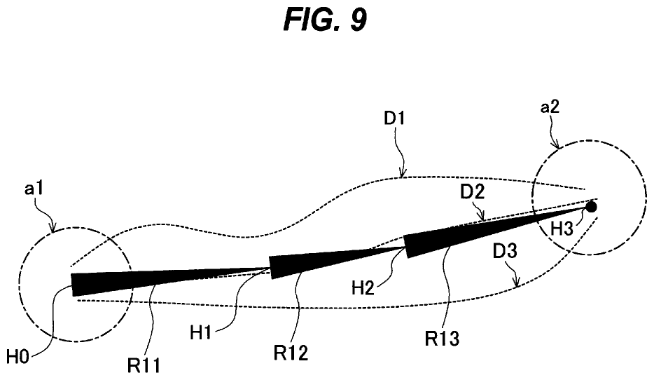

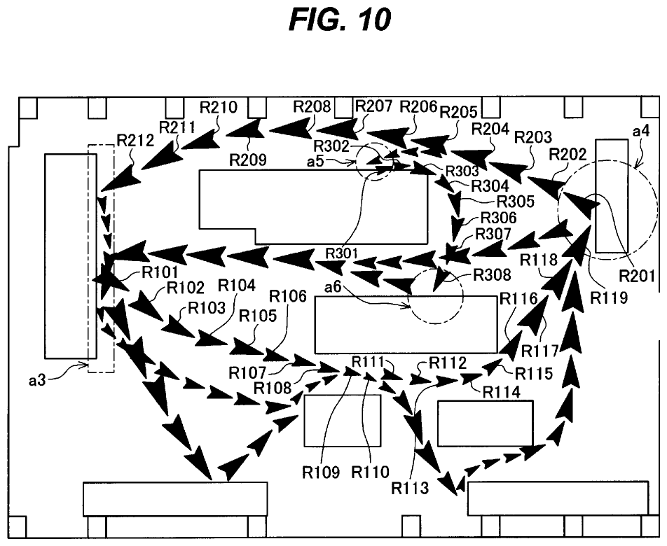

A display processing device of a second embodiment of the present invention will be described by using FIGS. 9 and 10. FIGS. 9 and 10 are diagrams illustrating representative movement lines by using arrows. In FIG. 9, the same reference characters as those in FIG. 6 indicate the same parts. While the drawing unit 112 of the first embodiment draws a line representing a representative movement line by connecting each of the average departure point, average points, and average arrival point, a drawing unit 112 of the second embodiment draws a representative movement line by using arrows R11, R12, and R13 as illustrated in FIG. 9. As illustrated in FIG. 9, the arrows R11, R12, and R13 are drawn to connect the average departure point H0 and the average point H1, the average point H1 and the next average point H2, and the average point H2 and the average arrival point H3. This provides the advantage that it is possible to perceive a movement direction of the moving bodies. The drawing unit 112 may indicate a direction in which the moving bodies moved, by drawing arrows represented with V shapes, vector shapes, or the like, instead of arrows like those illustrated in FIG. 9.

In FIG. 10, arrows R101 to R119 represented with V shapes represent a representative movement line of moving bodies with area a3 as a departure area and area a4 as an arrival area. Arrows R201 to R212 represent a representative movement line of moving bodies with area a4 as a departure area and area a3 as an arrival area. Arrows R301 to R308 represent a representative movement line of moving bodies with area a5 as a departure area and area a6 as an arrival area.

Here, the drawing unit 112 may draw the arrows such that the colors (densities, lightnesses, or saturations) and/or widths of the arrows vary depending on moving speeds of the moving bodies. Specifically, when the distance between adjacent average points is less than a threshold (i.e., the moving speed of the moving bodies is less than a threshold) as in arrows R106 to R115, the drawing unit 112 makes the density of the color of the arrow low, makes the saturation of the color of the arrow low, or makes the difference in lightness of the color of the arrow from a background color small, and when the distance between adjacent average points is not less than the threshold (i.e., the moving speed of the moving bodies is not less than the threshold) as in arrows R101 to R105 and R116 to R119, the drawing unit 112 makes the density of the color of the arrow high, makes the saturation of the color of the arrow high, or makes the difference in lightness of the color of the arrow from the background color large. This provides the advantage that it is possible to make it easy to perceive the variation in the moving speed of the moving bodies on the basis of the arrows drawn by the drawing unit 112. Multiple thresholds may be set as references for changing the colors (densities, lightnesses, or saturations) of the arrows. Also, when the moving speed of the moving bodies is less than a threshold, the drawing unit 112 makes the width small as in arrows R106 to R115, and when the moving speed of the moving bodies is not less than the threshold, the drawing unit 112 makes the width large as in arrows R101 to R105 and R116 to R119.

Also, the drawing unit 112 may draw the arrows such that the widths and/or colors (densities, lightnesses, or saturations) of the arrows vary depending on the number of the movement lines extracted by the movement line extraction unit 109. Specifically, when the number of the movement lines extracted by the movement line extraction unit 109 is less than a threshold, the drawing unit 112 makes the widths small as in arrows R301 to R308, and when the number of the extracted movement lines is not less than the threshold, the drawing unit 112 makes the widths large as in arrows R201 to R212. Also, when the number of the extracted movement lines is less than a threshold, the drawing unit 112 makes the densities of the colors low, makes the saturations of the colors low, or makes the differences in lightness of the colors from a background color small, as in arrows R301 to R308, and when the number of the extracted movement lines is not less than the threshold, the drawing unit 112 makes the densities of the colors high, makes the saturations of the colors high, or makes the differences in lightness of the colors from the background color large, as in arrows R201 to R212. This provides the advantage that it is possible to make it easy to perceive the frequency at which moving bodies moved, from the arrows drawn by the drawing unit 112. Multiple thresholds may be set as references for changing the widths and/or colors (densities, lightnesses, or saturations) of the arrows.

### 3. Third Embodiment

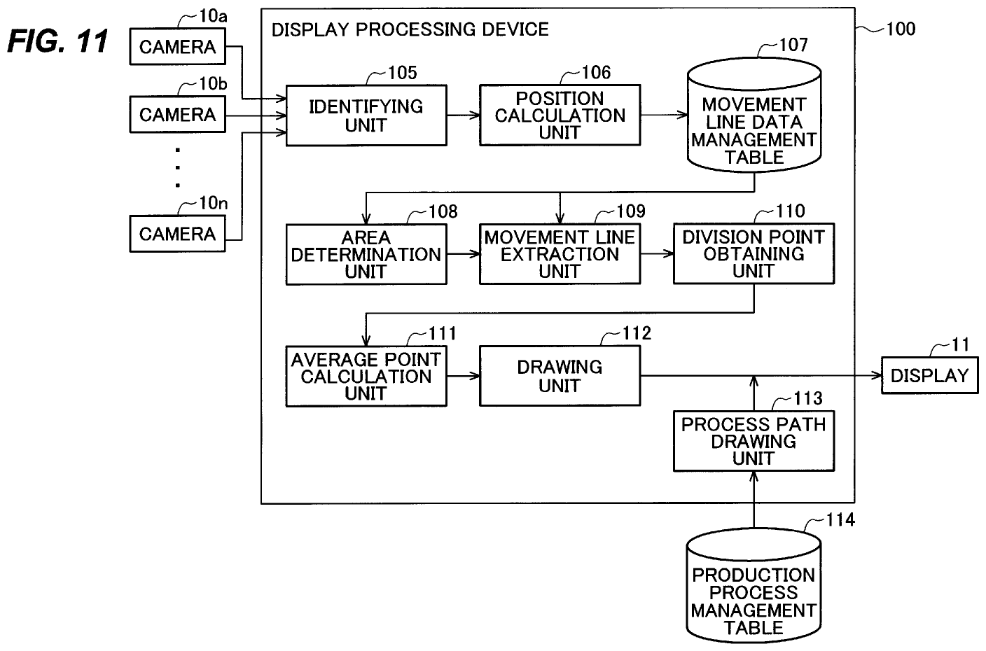

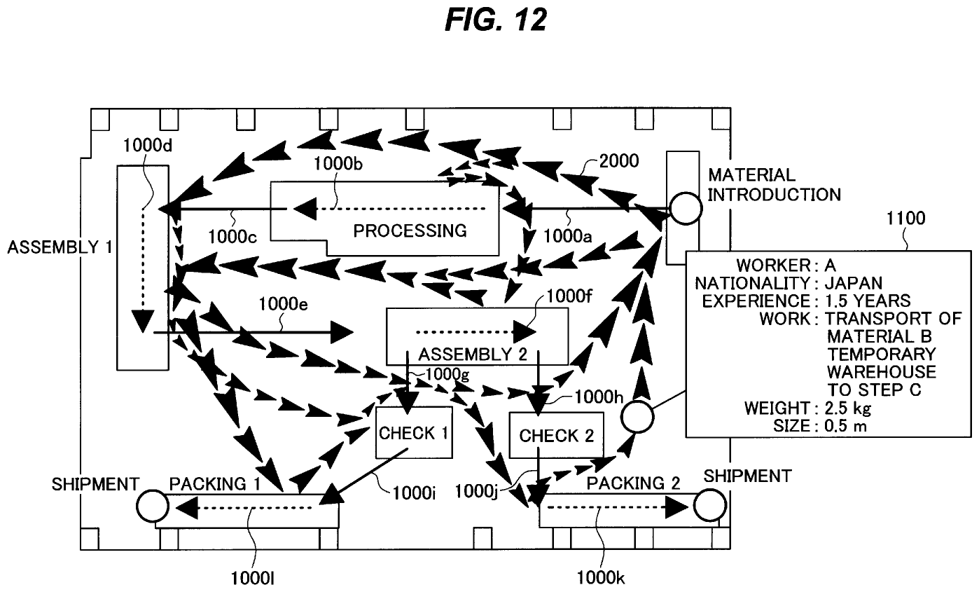

A display processing device of a third embodiment of the present invention will be described by using FIGS. 11 and 12. FIG. 11 is a configuration diagram of the display processing device according to the third embodiment, and is characterized in that a process path drawing unit 113 and a production process management table 114 are provided in addition to the display processing device according to the first embodiment illustrated in FIG. 1. In the production process management table 114, production process management data, which is also referred to as manufacturing execution system (MES) data, that is data for managing a work process procedure, receipt and shipment of goods, quality, maintenance, equipment, manufacturing execution, goods in process, or the like is recorded, and it includes at least process information (processing, assembly, check, packing, or the like) specifying the content of each step in a production line and process path information specifying the order of the steps. The process path information indicates a process path such as a flow of objects, such as parts, materials, or products, and/or a flow of work steps or production steps. The process path drawing unit 113 extracts the process path information and process information from the production process management data, and draws one or more arrows indicating the process path and/or the process information. The arrows indicating the process path and/or the process information drawn by the process path drawing unit 113 are displayed on the display 11 together with the arrows drawn by the drawing unit 112 in a superimposed manner. Hereinafter, in the case of making description while distinguishing between the respective arrows, the arrows drawn by the process path drawing unit 113 will be referred to as process path arrows, and the arrows drawn by the drawing unit 112 will be referred to as moving body arrows.

FIG. 12 illustrates an example of the display screen. Reference characters 1000a to 10001 indicate the process path arrows, and reference character 2000 indicates the moving body arrows. To distinguish between the process path arrows 1000 and the moving body arrows 2000, the process path arrows 1000 and moving body arrows 2000 are drawn as arrows that are displayed such that they are different in at least one of color (density, lightness, or saturation), solid line, dotted line, and width. Also, the process path drawing unit 113 may draw the process path arrows 1000 such that the process path arrows 1000 vary in color (density, lightness, or saturation), solid line, dotted line, and width depending on the content of each step, the work step, or the type of the object. In the example of FIG. 12, it is shown that the process path arrows 1000a to 1000c and moving body arrows 2000 are in the same direction, and workers move along the process path. Also, when a moving body arrow 2000 is selected through an operation means (not illustrated), such as a mouse, attribute information, a movement history, or the like of a worker is displayed as indicated by reference character 1100. Likewise, when a process path arrow 1000 indicating a work step is selected, the operation state, production state, maintenance state, quality state, or the like of equipment for the work step is displayed. As such, by displaying not only the moving body arrows 2000 indicating the manner of movement of workers but also the process path arrows 1000 indicating the process path in a superimposed manner, it is possible to visualize a correlation between the movement of the workers and the process path. This makes it easy to perceive movement of the workers and waste in the process path, and makes it possible to use it for improvement in working efficiency, such as layout improvement or manning in the factory.

### 4. Other Applications

The above examples are merely examples of implementation of the present invention, and applications obtained by adding or changing a configuration as described below are conceivable.

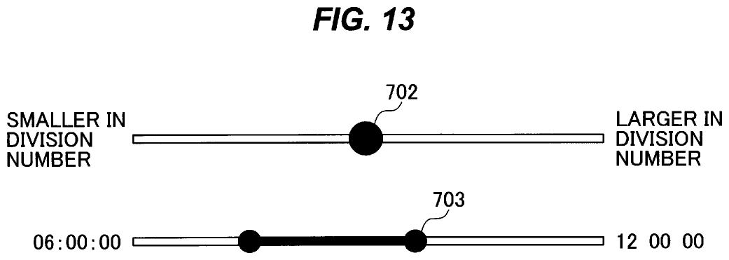

The division point obtaining unit 110 illustrated in FIG. 1 may receive a division number specified from an operation unit (not illustrated) through a slider bar displayed on the display 11. FIG. 13 is a diagram illustrating the slider bar displayed on the display 11. Element 702 is the slider bar for specifying the division number. The division point obtaining unit 110 may divide the movement lines by using the division number specified through the slider bar 702. Also, element 703 is a slider bar for specifying a range of time information, and functions as an example of a time information specifying unit of the present invention. The movement line extraction unit 109 illustrated in FIG. 1 may extract, from the movement line data management table 107, movement line data including time information included in the range of time information specified through the slider bar 703, and extract multiple movement lines represented by the movement line data. Moreover, the drawing unit 112 may draw the movement line such that the movement line successively varies depending on the division number and the range of time information specified through the slider bars 702 and 703. Also, the division point obtaining unit 110 may use a division number previously associated with the screen size or resolution of the display 11, or may use, as the division number, a numerical value specified from an operation unit (not illustrated).

The movement line extraction unit 109 illustrated in FIG. 1 may extract, from the movement line data management table 107, movement line data including identification information 301, such as a worker ID, or attribute information 302, such as a work area to which a worker is assigned, specified from an operation unit (not illustrated), and extract, from multiple movement lines represented by the movement line data, multiple movement lines passing through a departure area and an arrival area. This provides the advantage that it is possible to make it easy to perceive the manner of movement of moving bodies related to desired identification information 301 or attribute information 302.

The area determination unit 108 illustrated in FIG. 1 may determine the departure area on the basis of the types, such as a work area, a dedicated machine/robot installation area, a parts/product storage area, or an office, of areas where moving bodies stay for a given length of time, instead of or in addition to the lengths of staying times of moving bodies. Moreover, the arrival area may be determined on the basis of a combination of the type of the determined departure area and the types of works in which the manner of movement of moving bodies has a certain pattern, the types of works including production systems, such as functional production, line production, or cell production, and production steps, such as processing, assembly, check, packing, operation, or transportation. Specifically, when a production is performed in a certain work area by using a cell production system, since staying times of workers in areas other than the work area are generally short, it is possible to preferentially determine, as the arrival area, a parts/product storage area related to the work.

The area determination unit 108 illustrated in FIG. 1 may determine, as an average departure point or an average arrival point, positional coordinates, such as positional coordinates indicating centers of the areas determined by the area determination unit 108, that represent the respective areas. Then, the drawing unit 112 may draw a line that passes through the average departure point of the departure area, the N-1 average points, and the average arrival point of the arrival area. In this case, the average point calculation unit 111 need not calculate the average departure point and average arrival point.

The process of drawing a representative movement line obtained by averaging multiple movement lines performed by the above display processing device may be formed as a display processing method, or may be formed as a program for causing a computer to function.

In the above embodiments, the area determination unit 108 determines the departure area and/or arrival area on the basis of staying times of moving bodies, or the like. However, the way to determine the departure area and/or arrival area is not limited to this. For example, the departure area and/or arrival area may be manually set by an operation by a user of the display processing device, or may be set at the time of installation of the display processing device or other times.

In the above embodiments, coordinates of moving bodies are calculated on the basis of images imaged by cameras. However, the way to calculate coordinates of moving bodies is not limited to this, and any technique capable of calculating coordinates of moving bodies may be used. For example, the display processing device may obtain coordinates measured by communication terminals held by or located at moving bodies. Also, for example, the display processing device may calculate coordinates of moving bodies from radio waves from wireless tags, such as radio frequency identifier (RFID) tags or beacons, held by or located at the moving bodies. Also, for example, the display processing device may take, as coordinates of moving bodies, positions where various sensors that have detected the moving bodies are located.

### DESCRIPTION OF REFERENCE CHARACTERS

100 display processing device, 108 area determination unit, 109 movement line extraction unit, 110 division point obtaining unit, 111 average point calculation unit, 112 drawing unit.

What is claimed is:

1. A display processing device comprising:
a processor to execute a program; and
a memory to store the program which, when executed by the processor, performs processes of:
(a) extracting a plurality of movement lines representing trajectories of moving bodies that leave a first area and arrive in a second area and/or trajectories of moving bodies that leave the second area and arrive in the first area;
(b) obtaining, for each of the movement lines extracted by process (a), N-1 division points by dividing the movement line by a division number N, N being an integer not less than 2;
(c) calculating N-1 average points by averaging coordinates of the division points obtained by process (b) and belonging to the different movement lines; and
(d) drawing a movement line that passes through the N-1 average points obtained by process (c), the first area, and the second area.

2. The display processing device of claim 1, wherein
the movement lines are indicated by movement line data including coordinates indicating movement trajectories of the moving bodies and time information indicating times when the moving bodies were located at the coordinates, and
from the movement line data indicating the movement lines extracted by process (a), for each movement line, process (b) obtains a number of the coordinates constituting the movement line, and obtains the N-1 division points with a value obtained by dividing the number by the division number N as a sampling interval.

3. The display processing device of claim 2, wherein the program further performs a process of (e) specifying a range of time information, and
wherein process (a) extracts a plurality of movement lines indicated by movement line data including time information included in the range of time information specified by process (e).

4. The display processing device of claim 2, wherein the program further performs a process of (f) determining, from the movement line data, one or more areas where staying times of the moving bodies are long, and
wherein process (a) extracts movement lines with the one or more areas determined by process (f) as the first area and/or the second area.

5. The display processing device of claim 1, wherein process (d) draws the movement line such that the movement line indicates directions in which the moving bodies moved.

6. The display processing device of claim 1, wherein process (d) draws the movement line such that a color and/or a width of the movement line varies depending on a number of the movement lines extracted by process (a).

7. The display processing device of claim 1, wherein process (d) draws the movement line such that a color and/or a width of the movement line varies depending on moving speeds of the moving bodies.

8. The display processing device of claim 1, wherein the program further performs a process of (g) drawing an arrow indicating a flow of objects or steps.

9. A display processing method comprising:
extracting a plurality of movement lines representing trajectories of moving bodies that leave a first area and arrive in a second area and/or trajectories of moving bodies that leave the second area and arrive in the first area;
obtaining, for each of the extracted movement lines, N-1 division points by dividing the movement line by a division number N, N being an integer not less than 2;
calculating N-1 average points by averaging coordinates of the obtained division points belonging to the different movement lines; and
drawing a movement line that passes through the calculated N-1 average points, the first area, and the second area.

10. A non-transitory computer-readable storage medium storing a program for causing a computer to execute:
extracting a plurality of movement lines representing trajectories of moving bodies that leave a first area and arrive in a second area and/or trajectories of moving bodies that leave the second area and arrive in the first area;
obtaining, for each of the extracted movement lines, N-1 division points by dividing the movement line by a division number N, N being an integer not less than 2;
calculating N-1 average points by averaging coordinates of the obtained division points belonging to the different movement lines; and
drawing a movement line that passes through the calculated N-1 average points, the first area, and the second area.
